(19) United States
(12) Patent Application Publication
(10) Pub. No.: US 2013/0033023 A1
(43) Pub. Date: Feb. 7, 2013

(54) SAFETY DEVICE FOR A MOTOR VEHICLE

(71) Applicant: Ulrich RICK, Braunweiler (DE)

(72) Inventor: Ulrich RICK, Braunweiler (DE)

(73) Assignee: GM GLOBAL TECHNOLOGY OPERATIONS LLC, Detroit, MI (US)

(21) Appl. No.: 13/565,925

(22) Filed: Aug. 3, 2012

(30) Foreign Application Priority Data
Aug. 5, 2011 (DE) 10 2011 109 635.7

(51) Int. Cl. B60R 21/23; B60R 21/213; B60R 21/207; B60R 21/205; B60R 21/206; B60R 21/214; B60R 21/203

(52) U.S. Cl. 280/731; 280/743.1; 280/732

(57) ABSTRACT

A motor vehicle with an interior covering is provided, which is movable and/or deformable relative to a vehicle body, and with a safety device, which includes, but is not limited to an expansion body with an elastic diaphragm, which delimits a hollow space. The filled expansion body is arranged between the interior covering and the vehicle body.

### CROSS-REFERENCE TO RELATED APPLICATION

This application claims priority to German Patent Application No. 10 2011 109 635.7, filed Aug. 5, 2011, which is incorporated herein by reference in its entirety.

### TECHNICAL FIELD

The technical field relates to a motor vehicle with a vehicle body, an interior covering and a safety device.

### BACKGROUND

From DE 10 2005 052 532 B3, an inflatable airbag cushion with a blown elastomer core is known, which upon filling emerges from an airbag housing in order to form a highly flexible impact surface with undefined surface contour for an occupant. From DE 102 54 488 A1 an elastic, completely prefilled diaphragm is known, wherein the diaphragm itself forms a surface of the interior covering and accordingly is susceptible to damage. DE 103 53 447 A1 discloses an A-pillar for a motor vehicle body with an exterior covering, which can be extended through a pneumatic adjusting element having an elastic diaphragm for the protection of passers-by. This does not contribute to occupant protection.

At least one object is to make available a motor vehicle with an improved safety device, which at least reduces or avoids one of the aforementioned disadvantages. In addition, other objects, desirable features and characteristics will become apparent from the subsequent summary and detailed description, and the appended claims, taken in conjunction with the accompanying drawings and this background.

### SUMMARY

According to an embodiment, a motor vehicle comprises a vehicle body and an interior covering, which is movable relative to the vehicle body and/or elastically and/or plastically deformable. The interior covering can preferentially be an interior covering of a pillar, in particular of an A-pillar, B-pillar, C-pillar or D-pillar of the vehicle body, a covering of a roof headlining and/or roof frame, a steering column, a footwell or a vehicle seat, or an instrument panel. In a further embodiment, the interior covering is designed in two or multiple parts. In a further embodiment, only one or a plurality of parts of the interior covering are movable relative to the vehicle body and/or deformable.

Elastic or plastic deformability in this case is to mean in particular a deformability away from and/or towards the vehicle body or a carrier, which is fixed relative to the vehicle body, for example a steering column. Preferentially through a safety device that is explained in the following and/or an impact of an occupant on the interior covering due to an accident a deformation of at least approximately 5 mm, preferentially at least approximately 10 mm is brought about. A corresponding movability can be provided in particular through hinges, guides and the like.

The motor vehicle comprises a safety device having one or a plurality of expansion bodies with an elastic diaphragm, which in each case delimits at least one hollow space. The completely filled expansion body is also still arranged between the interior covering or its movable parts and the vehicle body.

In another embodiment, one or a plurality of the hollow spaces are permanently prefilled completely or at least partially with a filling fluid, preferentially a gas, in particular air, so that the diaphragm or diaphragms are elastically elongated at least partially. In addition or alternatively, a filling fluid source for filling one or a plurality of hollow spaces subject to further elastic expansion of the diaphragm if applicable and a control device for the accident-based activation of the filling fluid source can be provided.

Through a passage safety device with expansion bodies that are completely prefilled permanently the passage safety of the vehicle can be increased, since the interior covering in the event of an impact of a vehicle occupant can yield towards the vehicle body subject to further elastic deformation of the expansion body or expansion bodies. At the same time, the elastic diaphragm which is thus sensitive as a rule is protected by the interior covering from environmental influences, in particular damage.

Through an active safety device, with which one or a plurality of expansion bodies are filled through the filling fluid source, the interior covering can be adjusted towards the occupant if required and a resilience made available, while without activation of the filling fluid source the elastic diaphragm can be stowed between interior covering and vehicle body in a highly space-saving manner. In addition, through the interior covering that remains in front of the expansion body, a defined surface and if applicable through its movability or deformability, a predetermined expansion kinematic can be realized.

In another embodiment, both concepts are combined with each other, in that one or a plurality of expansion bodies are partially filled permanently even prior to an accident and are completely filled by the filling fluid source based on an accident. This reduces the filling fluid quantity to be made available by the filling fluid source and can already provide passive protection even without activation of the filling fluid source. In addition or alternatively, it can in this case be provided for the further filling of one or a plurality of already permanently partially prefilled hollow spaces that one or a plurality of hollow spaces are only permanently prefilled and/or one or a plurality of hollow spaces are only filled based on an accident.

In another embodiment, one or a plurality of expansion bodies are fastened to a side of the interior covering facing away from the vehicle interior. In addition or alternatively, one or a plurality of expansion bodies can be fastened to the vehicle body. Equally, these can be fastened to a carrier, which is fixed relative to the vehicle body, an expansion body fastened to such a carrier is also arranged between the interior covering and the vehicle body.

In another embodiment, a spacing is provided between a not prefilled or permanently partially prefilled expansion body and the interior covering, a carrier or the vehicle body. Because of this, a resilience on the one hand can be made available in addition because of the movability and/or deformability of the interior covering and wear of the expansion body through an interior covering, vehicle body or carrier located opposite the expansion body and spaced from said expansion body can be avoided in accident-free operation or at least reduced. With an active safety device, an initial free filling of the expansion body can be additionally advantageous, which is initially not hindered by an already applied interior covering, vehicle body or carrier.

A diaphragm is to mean in particular a body whose wall thickness relative to its surface is small in an elastic, non-deformed state, in particular a body. The quotient of wall thickness divided by the surface is a maximum of approximately 0.05%, preferably a maximum of approximately 0.01%, as is the case for example with a rectangular plate with approximately 10 cm edge length and approximately 1 mm wall thickness (1/(100×100)=0.01%).

An elastic diaphragm is to mean in particular a diaphragm that can be greatly deformed elastically, in particular a diaphragm the elongation at break for example in the tensile test according to DIN 53504, amounts to at least approximately 100% and preferentially at least approximately 500% and/or the modulus of elasticity at room temperature amounts to a maximum of approximately 0.5 GPa, preferentially a maximum of approximately 0.1 GPa.

In another embodiment, an elastic diaphragm comprises one or a plurality of elastomers, in another embodiment it consists thereof. An elastomer can in particular be natural or synthetic rubber, silicone or a thermoplastic elastomer (TPE). Preferentially, an elastic diaphragm is fluid-tight with respect to a filling fluid. However, when an adequately large filling fluid flow is available, a diaphragm can also have a certain fluid permeability.

A diaphragm can be embodied in single or multiple layers. In particular, reinforcement elements such as for example bands, areal elements or nets, preferentially from textile material can be locally arranged on a diaphragm, which have a greater modulus of elasticity and which therefore expand less during a filling. In particular, reinforcement elements can be materially connected partially to a complete side with the inside and/or outside of the diaphragm, for example glued, welded, laminated-in or vulcanized-on. The elastic diaphragm then expands during filling in a substantially tied-up manner through reinforcement elements connected with it in places and functioning as catching bands or besides the reinforcement elements completely connected to it, so that these influence the shape and expansion characteristic of the filled diaphragm.

The filling fluid source is equipped for filling at least one hollow space of at least one expansion body with a filling fluid, in particular with a gas, preferentially with air. The filling fluid source can in particular comprise one or a plurality of pyrotechnical and/or pressure gas generators. The filling fluid source can supply one or a plurality of hollow spaces of one or a plurality of expansion bodies, it can additionally supply also one or a plurality of further inflatable airbags. In addition or alternatively, two or more filling fluid sources for filling the same hollow space can be provided.

In a further embodiment, a filling fluid source comprises one or a plurality of micro gas generators (MGG). In particular, a filling fluid source can then be arranged in the same component as the expansion body, preferentially formed as constructional unit with said expansion body and in particular be arranged directly on or even in a hollow space of the expansion body.

In another embodiment, the filling fluid source is connected to a control device of the safety device which is equipped in order to fill one or a plurality of hollow spaces of the expansion body or of the expansion bodies on the basis of an activation signal, which for example is transmitted to the control device by one or a plurality of spacing, delay, deformation and/or force sensors. For this purpose, the control device can comprise in particular a computation unit for processing the activation signal, a valve device in order to fluidically connect the filling fluid source to the hollow space or to the hollow spaces, and/or an ignition device for the pyrotechnical liberation of filling fluid.

According to another embodiment, one or a plurality of expansion bodies each comprise a hollow space and one or a plurality of further hollow spaces. Because of this, it becomes advantageously possible, on the one hand, to optimize individual hollow spaces geometrically with respect to their production and/or filling. On the other hand, by combining two or more fillable hollow spaces a desired outer contour, in particular envelope, and/or a desired force distribution of the respective expansion body over the interior covering can be realized in a design filling state.

Design filling state here is the description in particular of a state in which the expansion body is filled with the filling fluid under reference conditions, in particular at a reference temperature which for example can amount to approximately −10° C., approximately 0° C., approximately 10° C., approximately 20° C. or other standard temperatures for the operation of the motor vehicle, with a reference filling pressure, with a reference filling fluid quantity, at a reference maximum elongation which for example can amount to approximately 100%, 2 approximately 50% or approximately 500% or the like. In such a design filling state, the expansion body assumes a predetermined outer contour, which in addition to the movability or deformability of the interior covering is predetermined in particular through the shape of the elastic diaphragm and, in an another, through reinforcement elements.

In a preferred embodiment, two or more, in particular, all hollow spaces of an expansion body in the design filling state have different volumes and/or outer contours. Equally, two or more, in particular all hollow spaces of an expansion body in the design filling state can have same volumes and/or outer contours. Preferred outer contours are in particular geometrical basic bodies such as polyhedrons, in particular cuboids, cylinders, cones, ellipsoids, in particular spheres, pyramids or the like. By combining a plurality of same and/or different volumes and/or outer contours, expansion bodies with most diverse envelopes can thus be realized through hollow spaces that are simple to produce and/or to fill.

In technical terms, envelope is the term used to describe a surface that is smooth in particular, i.e., steadily curved, which with minimum area size encloses all hollow spaces. For illustration, an envelope can be imagined for example as a rubber skin stretched over the outer contours of the hollow spaces. The envelope can be purely virtual and thus describe the total outer contour of the hollow spaces mathematically. Thus, a cylindrical hollow space, which on the outside is surrounded by further cylindrical hollow spaces of a lesser height, for example has a cone-shaped virtual envelope.

Equally, in another embodiment, a more preferably folded, preferentially textile and/or elastic envelope can be provided which envelopes two or more, in particular all hollow spaces jointly entirely or partially and thus smoothes, in particular, possible edges of the individual hollow spaces. In addition or alternatively, the expansion body can comprise an envelope which completely or partially encloses an elastic diaphragm. This envelope, too, can in particular be folded, preferentially textile, and/or elastic, in particular of diaphragm material.

In another embodiment, two or more, in particular all hollow spaces in the design filling state have different filling pressures. Through different filling pressures, locally different elasticities and dampings can be advantageously realized. In particular, pressureless or hollow spaces can also be provided, in which only ambient pressure is present. Equally, two or more, in particular all hollow spaces of an expansion body can have same filling pressures in the design filling state, which can facilitate the design and/or filling.

The filling pressure of a hollow space in the design filling state can be influenced on the one hand through a control device for setting the filling behavior. In addition or alternatively, the filling pressure of a hollow space in the design filling state can be influenced through a device for emptying, for example one or a plurality of preferentially controllable outward ventilation openings.

One such device for setting the filling and/or emptying behavior can comprise in particular one or a plurality of valves, chokes or the like, which are arranged between the hollow space and the filling fluid source or a filling fluid sink, in particular of the surroundings. In particular, when in a preferred embodiment a fluid passage between two or more hollow spaces is provided, in order to fill the hollow spaces through the same filling fluid source(s) in this way or to empty these into the filling fluid sink, this fluid passage can be variable through the control device, for example in that a valve—at least partially—is opened or closed. In a preferred further development, the control device is equipped for setting different filling and/or emptying behaviors of two or more hollow spaces.

In another embodiment, the further hollow space or hollow spaces are each entirely or partially delimited by a further elastic diaphragm. The diaphragms, which delimit different hollow spaces, can be interconnected. In another embodiment, two or more, in particular all diaphragms each of which delimit a hollow space are releasably or materially interconnected, so that a continuous expansion body with a plurality of hollow spaces is obtained. To this end, the diaphragms can be individually produced and subsequently interconnected through buttoning, clamping, gluing, welding, vulcanizing or the like. Equally, diaphragms which delimit different hollow spaces can also be produced integrally with one another, wherein this entire diaphragm can then be thought to be divisible into the different diaphragms delimiting the individual hollow spaces.

In another embodiment, one or a plurality of hollow spaces jointly enclose and/or in each case at least one recess that is open on one or both sides at least partially, which according to another embodiment can be closed by a covering. The covering is preferentially directly connected to the diaphragm, in particular materially connected, for example through gluing, welding, vulcanizing or the like, or indirectly, in particular via bands or the like. For example a ring or donut-shaped hollow space completely encloses a recess that is open on both sides, a hollow space with a cross section in the shape of an eight completely to recesses that are open on both sides, a cuboid with a blind hole-like pocket completely a recess that is open on one side and a C-ring-shaped hollow space, i.e., with a circular cross section and a gap in circumferential direction, a recess partially. A hollow space encloses a recess in the sense of the present invention at least partially in particular than, when the circumference of the recess delimited by the hollow space delimits at least approximately 75%, preferentially at least approximately 85% of its total circumference. Thus, a ring of a circle segment, which extends for example over an angular range of approximately 315%, i.e., has a gap of approximately 45%, encloses for example approximately 87.5% of the recess located inside (approximately 315°/360°=87.5%). Such gaps in the circumference, i.e. an only partial enclosure is possible when the face ends of the hollow space delimiting the gap(s) are tied to one another through the covering and/or holding means, in particular one or a plurality of bands, ropes or the like. This prevents an excessive enlargement of the recess subject to the moving apart of the hollow space face ends. In another embodiment, the hollow space or hollow spaces enclose the recess completely or over its entire circumference. For example, four hollow spaces connected to one another at their ends into a circular ring, each of which have a quarter of a circular segment-shaped cross section, jointly enclose the recess in the middle of the circular ring.

In another embodiment, a covering closes off the recess. To this end, the covering can be designed closed or continuous, in particular of the same material as the elastic diaphragm and/or of a textile material. Equally, the covering can also have one or a plurality of through-openings and in particular be designed in the manner of a net or grid, preferentially in turn from textile and/or diaphragm material. A textile net or grid-like covering is to mean in particular a covering of preferentially stranded threads.

If the covering comprises diaphragm material, it can elastically expand during the filling of the hollow space in order to cover the enlargement recess. If the covering is at least partially of textile and thus less elastic material than the diaphragm, it can, in an advantageous further development, opens out during filling and so adapt to the enlarging recess.

According to another, one or a plurality of hollow spaces in each case are partially delimited by a material which opens out upon being filled. The enlargement of the hollow space is thus realized during the filling by combining the elastic expansion of the diaphragm and the unfolding of a material that is less elastic compared with the former. Because of this, the shape and expansion characteristic in particular can be influenced, while larger filling volumes can also be realized relative to expansion bodies the hollow spaces of which become larger only through expansion of an elastic diaphragm. Fabric here is to mean a single or multi-ply fabric, such as it is known for example from conventional unfolding airbags. In particular, the material can be materially connected to the elastic diaphragm, preferentially glued, welded or vulcanized-on.

In another embodiment, an inward ventilation and/or outward ventilation opening is arranged in the material. In this manner, the load that occurs on the circumference of such an opening can be introduced into the expansion body by way of the material that is better suited for this purpose.

According to an embodiment, the elastic diaphragm is releasably fastened to a carrier which co-delimits the hollow space. According to another embodiment, it is fastened to the carrier through forming or casting of the carrier and/or materially fastened to the carrier in particular through vulcanizing, gluing and/or welding. In particular, the carrier can form a flange of a gas generator of the filling fluid source, an expansion body housing, in which the unfilled expansion body and preferentially also the gas generator are arranged, or form an expansion body covering that is intended in order to be folded away from the expanding expansion body and/or destroyed. Equally, the carrier can be an element of the vehicle structure, in particular of the vehicle body and preferentially of a roof frame of the vehicle, an element of the vehicle interior covering such as for example of an instrument panel, of a steering wheel, of a door or pillar covering or of a roof headlining, or an element of a vehicle seat. The carrier can also form a part of one of the aforementioned components, for example the bottom of an expansion body housing or of a brace of the vehicle body. Preferentially, the carrier serves for fixing the expanding expansion body to the vehicle, it can additionally predetermine locally the shape of the expansion body in the filled state with the fastening contour.

In particular, the carrier can be designed frame-like for this purpose. Equally, the carrier can also be designed as a flat or curved plate. In another embodiment, at least one inward ventilation and/or at least one outward ventilation opening is/are arranged in the carrier. In this manner, the load that occurs on the circumference of such an opening can be absorbed by the carrier that is better suited for this purpose.

With its region adjoining the fastening contour, the carrier locally defines the hollow space or hollow spaces together with the elastic diaphragm. To this end, the carrier is preferentially produced in particular from a plastic, in particular thermoplastic and/or a metal and embodied filling fluid-tight. If an adequately large filling fluid flow is available, the carrier can also have a certain fluid permeability.

In an embodiment, the diaphragm is fastened to the carrier through a clamping connection, in particular through screwing or flanging. The diaphragm can be releasably fastened to the carrier in particular through screwing. Advantageously, this can make possible a simple assembly and in particular a replacement of a damaged or used diaphragm. In order to be able to achieve an adequately fluid-tight fastening between diaphragm and carrier, screws can be arranged so tightly next to one another in another embodiment, that the local pressure points of the diaphragm caused by these merge with one another, i.e., the diaphragm is pressed against the carrier alongside the entire fastening contour, thus being held on said carrier through frictional connection. In addition or alternatively, a support element, for example in the form of individual washers or of a in particular frame-like flange having bores for a plurality of screws, can be arranged on the surface of the diaphragm facing away from the carrier, which introduces the normal force applied by the screws into the diaphragm over a larger surface area.

In particular, the diaphragm can be fastened to the carrier through seaming of the carrier. To this end, said carrier can be suitably formed plastically, which is to mean in particular flanging, tumbling, caulking and the like. Seaming of the carrier in particular is to mean forming a spacing between two continuous surfaces of the carrier located opposite each other, in which an edge of the diaphragm is held in a clamped and/or materially joined connection. Here, the diaphragm can be initially placed on one of the surfaces and the carrier subsequently deformed plastically. Equally, the carrier can initially be suitably formed or cast with the spacing in particular of plastic and the edge of the diaphragm subsequently introduced into said space, wherein said edge in a preferred further development in the un-deformed state has a greater wall thickness than the spacing, is introduced in the spacing subject to elastic deformation where it only partially relaxes, so that it is clamped through frictional connection between the surfaces of the carrier. In addition or alternatively, the diaphragm can also be materially connected to one or both surfaces of the carrier, in particular, glued.

In particular, the diaphragm can be fastened to the carrier in that an edge of one of the diaphragm and the carrier is fastened in a groove of the other one of the carrier and the diaphragm. To this end, the groove can be initially produced and then the edge cast in it. Equally, the edge can be produced initially and during the casting of the other one of carrier and the diaphragm, enclosed by said other one, so that the groove is formed. In particular, the diaphragm can be insert-molded at its edge with the plastic forming the carrier. In a preferred further development, groove or edge can have a narrower web region which merges into a region that is wider compared to this, which through positive connection counteracts a pulling-out of the edge from the groove.

Additionally or alternatively, the diaphragm can be fastened to the carrier in that one or a plurality of protrusions of one of the diaphragm and the carrier is fastened in the other one of the carrier and the diaphragm. Here, the protrusions and the recesses can be initially produced and then the protrusions introduced in the recesses subject to elastic deformation of protrusion and/or recess. Equally, it is possible to cast the recesses about the protrusions or conversely cast the protrusions in the recesses. A protrusion can have a narrower region, which merges into a region that is wider compared to this, which through positive connection counteracts a pulling-out of the protrusion from the recess. Additionally or alternatively, edge and groove or recesses and protrusions can be fastened to each other through frictional and/or materially joined connection, in particular glued together. In another embodiment, the diaphragm is fastened to the carrier through vulcanizing. This can be combined in particular with one of the aforementioned positive fastenings. Equally, the diaphragm can also be vulcanized onto the carrier and thus adhere to said carrier without a separate adhesive being required for this purpose.

In another embodiment, at least one cavity comprises one or a plurality of outward ventilation openings. Through their size and/or arrangement, a desired characteristic, in particular filling kinematic, stiffness and/or damping of the expansion body can be predetermined.

### BRIEF DESCRIPTION OF THE DRAWINGS

The present invention will hereinafter be described in conjunction with the following drawing figures, wherein like numerals denote like elements, and:

FIG. 1 is an interior of a motor vehicle according to an embodiment; and

FIGS. 2A-2C are in each case a section along the line II-II in FIG. 1 for different embodiments.

### DETAILED DESCRIPTION

The following detailed description is merely exemplary in nature and is not intended to limit application and uses. Furthermore, there is no intention to be bound by any theory presented in the preceding background or summary or the following detailed description.

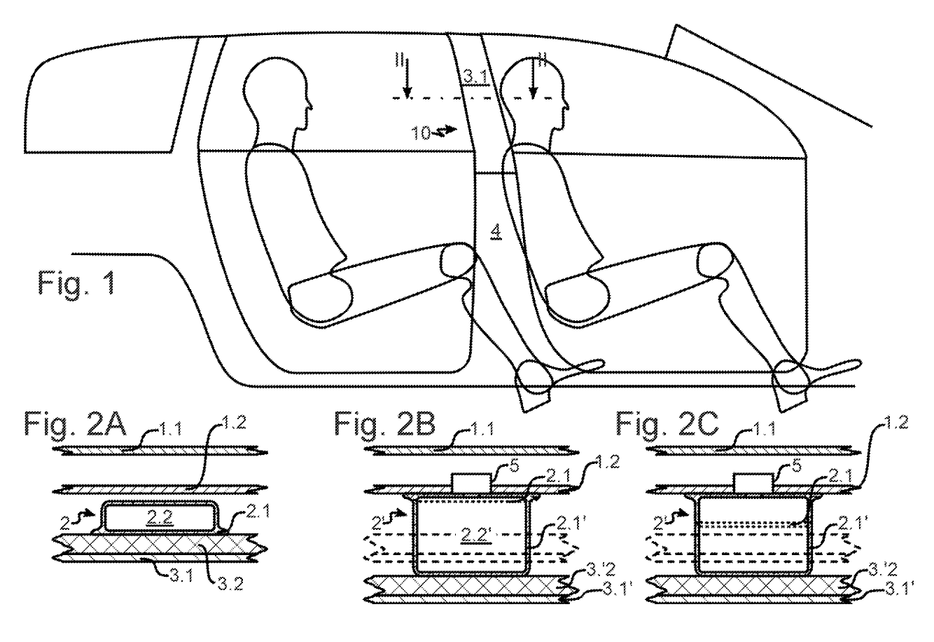

FIG. 1 shows, highly schematically seen from the inside, an interior of a passenger car with a B-pillar 10. Towards the interior, this is covered by a two-piece interior covering having a lower part 4 fixed to the body and an upper interior covering part, which is shown in more detail in the sections of FIG. 2A-2C. The two-layered upper interior covering part comprises a textured or upholstered layer 3.2, for example of plastic, which on the interior side is covered by a lining 3.1, for example of leather, artificial leather and/or textile material.

This interior covering part 3.1, 3.2 lines the B-pillar 10, as is evident in the sections of FIG. 2A-2C, as hollow profile 1.1, 1.2 forms a part of the vehicle body. This is only exemplary, other parts of the vehicle body or carriers which are fixed relative to said body could be covered, wherein carrier in the sense of the present invention does not imply any restrictions with respect to shape, strength, function and the like.

According to an embodiment shown in section of FIG. 2A, a passive safety device is provided in that between interior covering 3.2 and vehicle body 1.2 an expansion body 2 is arranged, which comprises an elastic diaphragm 2.1 of natural or synthetic rubber, which delimits a hollow space 2.2. The expansion body 2 or its diaphragm 2.1 is materially connected to the interior covering 3.2, for example glued, welded or vulcanized. Its hollow space 2.2 is permanently filled completely with air, i.e. no further filling of the already elastically elongated diaphragm 2.1 is intended.

Between the expansion body 2 and the vehicle body 1.2, a spacing is provided, so that relative movements of the interior covering 3.2 not result in any abrasion of the expansion body 2 on the vehicle body 1.2. In the case of an accident-induced impact of an occupant on the interior covering 3.1, said interior covering yields towards the vehicle body 1.2 elastically or plastically or in joints, in particular guides or hinges which are not shown. Initially the initial spacing between expansion body 2 and vehicle body 1.2 is used up before subsequently the expansion body 2 deforming between vehicle body 1.2 and interior covering 3.1 in the process decelerates a movement of the occupant.

FIG. 2B shows in a representation corresponding to FIG. 2A a further embodiment. Elements corresponding to one another are designated through identical reference characters so that in the following only the differences to the embodiment of FIG. 2A are discussed. On the one hand, the expansion body 2 is not fastened to the interior covering 3.2, but to the vehicle body 1.2. On the other hand, the second embodiment is an active safety device. To this end, said safety device comprises a filling fluid source in the form of a microgas generator 5, which is activated by a control device (not shown) when said control device senses an accident that is imminent or that has already occurred.

In this case, the microgas generator 5 fills the hollow space 2.2 of the expansion body 2 which in the accident-free operation is not elastically deformed so that said expansion body expands subject to elastic elongation of the diaphragm 2.1, in the process touches the interior covering 3.2, adjusting it towards the occupant (i.e., towards the vehicle interior subject to deformation or movement of the covering in joints (toward the bottom in FIG. 2B). In order to illustrate this operation, the state of the expansion body and of the undeformed or unmoved interior covering are indicated in FIG. 2B with interrupted lines. In solid representation and distinguished with an apostrophe are the completely filled state of the expanded expansion body 2′ with elastically elongated diaphragm 2.1′ and completely filled hollow space 2.2′ and the interior covering 3.1′, 3.2′ adjusted towards the occupant.

FIG. 2C shows a further embodiment corresponding to the representation in FIG. 2A, 2B. Elements corresponding to one another are designated by identical reference characters, so that in the following only the differences to the embodiments of FIG. 2A, 2B are discussed. With the embodiment of FIG. 2C, the two above concepts are combined into an active-passive safety device. To this end, the expansion body is already partially prefilled permanently and in this state, as indicated in FIG. 2C by an interrupted line, approximately has the shape of the expansion body 2 of the embodiment of FIG. 2A. When the control device senses an accident that is imminent or has already occurred, it completely fills the expansion body in the manner explained with reference to FIG. 2B, wherein its diaphragm 2.1 is further elongated in the state 2.1′ and it now adjusts the interior covering 3.1′, 3.2′ towards the occupant.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A motor vehicle, comprising:
an interior covering that is movable relative to a vehicle body;
a safety device having an expansion body with an elastic diaphragm that delimits a hollow space,
wherein the expansion body in a filled state is arranged between the interior covering and the vehicle body.

2. The motor vehicle according to claim 1, wherein the safety device further comprises:
a filling fluid source that is configured to fill a hollow space subject to elastic expansion of the elastic diaphragm; and
a control device that is configured to an accident-based activation of the filling fluid source.

3. The motor vehicle according to claim 1, wherein the hollow space is at least at least partially prefilled.

4. The motor vehicle according to claim 1, wherein the interior covering is a pillar covering.

5. The motor vehicle according to claim 1, wherein the interior covering is a roof covering.

6. The motor vehicle according to claim 1, wherein the interior covering is an instrument panel.

7. The motor vehicle according to claim 1, wherein the interior covering is a steering column covering.

8. The motor vehicle according to claim 1, wherein the interior covering is a, footwell covering.

9. The motor vehicle according to claim 1, wherein the interior covering is a seat covering.

10. The motor vehicle according to claim 1, wherein the expansion body is fastened to an interior covering.

11. The motor vehicle according to claim 1, wherein the expansion body is fastened to a carrier.

12. The motor vehicle according to claim 1, wherein the expansion body is fastened to the vehicle body.

13. The motor vehicle according to claim 1, further comprising a spacing between a maximally partially filled expansion body and the interior covering.

14. The motor vehicle according to claim 11, wherein a carrier co-delimits the hollow space and in that the elastic diaphragm is releasably fastened to the carrier.

15. The motor vehicle according to claim 1, wherein the expansion body comprises at least one further hollow space.

16. The motor vehicle according to claim 1, wherein a hollow space encloses at least partially a recess that is open on at least one side and preferentially closed off by a covering.

17. The motor vehicle according to claim 1, wherein the expansion body comprises an envelope that at least partially encloses the elastic diaphragm.
